(19) United States
(12) Patent Application Publication
(10) Pub. No.: US 2005/0189287 A1
(43) Pub. Date: Sep. 1, 2005

(54) Slurry expressing and liquid displacing device

(75) Inventors: Heng-I Lin, Taipei Hsien (TW); Feng-Ming Chuang, Taipei Hsien (TW); Hsu Tsang Lin, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Liung Feng Industrial Co., Ltd.

(21) Appl. No.: 10/786,119

(22) Filed: Feb. 26, 2004

(51) Int. Cl. B01D 29/35; B01D 29/33; B01D 29/64; B30B 9/14

(52) U.S. Cl. 210/415; 210/413; 100/117

(57) ABSTRACT

The present invention provides a slurry expressing and liquid displacing device which is used to express slurry and then separate out effluence and solid of the slurry through radial pore volume displacement of continuous filtration and washing for getting high purity solid. The slurry expressing and liquid displacing device includes a expressing mechanism, a displacing mechanism, a blender, a collecting tube, and first and second storage troughs. The expressing mechanism includes a first helical transmission shaft having a compression zone for transporting and efficiently compressing the slurry. The displacing mechanism includes a second helical transmission shaft rotatably connected with the first helical transmission for connecting with displacing liquid such as water. A plurality of through holes is disposed at the side surface of the second helical transmission shaft to radially spray through for facilitating the displacing liquid to flow out therethrough. Thus effluence and solid of the slurry are efficiently separated out thereby shortening the time required for operation and increasing separating efficiency.

### BACKGROUND OF THE INVENTION

1. Field of the Invention

The present invention relates to a slurry expressing and liquid displacing device, and particularly to a slurry expressing and liquid displacing device which expresses slurry and then separates out effluence and solid of the slurry through radial continuous filtration and washing for getting high purity solid.

2. Prior Art

One method that has been used for separating a mixture into solid and liquid component, is a separating apparatus which includes a filter permeable to the liquid component against which the mixture is urged to separate the liquid component. The solid component is substantially scraped from the filter wall, as for example as shown in U.S. Pat. Nos. 3,587,859, 4,491,462, 4,705,624, 6,467,305 and so on.

However, the constructions of the separating devices disclosed at above mentioned US patents have a common shortage that the transportation direction of slurry and the separated effluence of slurry are axially configured. Thus, during the course of effluence-solid separation, the slurry has to pass through a relatively long treatment path and so the operating time is relatively long. Furthermore, the slurry is transported by gravity in the above mentioned US patents, and so the transportation rate is low, which results in the low efficiency.

### SUMMARY OF THE INVENTION

Accordingly, an object of the present invention is to provide a slurry expressing and liquid displacing device in which the direction of slurry treatment and the separated effluence of slurry are radially configured thereby shortening the path of displacing and so shortening the time required for operation and increasing separating efficiency through high transportation rate.

To achieve the above-mentioned object, a slurry expressing and liquid displacing device in accordance with the present invention is for expressing slurry and then separating out effluence and solid of the slurry through radial pore volume displacement of continuous filtration and washing. The slurry expressing and liquid displacing device includes a expressing mechanism, a displacing mechanism, a blender, a collecting tube, and first and second storage troughs. The expressing mechanism includes a driving motor, a transportation tube with a plurality of screens located on the periphery surface opposite to the collecting tube, which has an inlet at an end thereof near the driving motor and an outlet at the other end thereof, and a first helical transmission shaft rotatably connected with the driving motor. The first helical transmission shaft has a transportation zone at an end thereof near the inlet and a compression zone at the other end. The displacing mechanism disposed in the transportation tube includes a second helical transmission shaft rotatably connected with the first helical transmission. The second helical transmission shaft is hollow with a plurality of through holes being defined at the side surface thereof. A connecting port is formed at an end of the second helical transmission shaft. The blender is formed at the rear of the displacing mechanism and in the transportation tube corresponding to the outlet. The collecting tube is formed at the outside of the transportation tube between the compression zone and the displacing mechanism and kept properly spaced from the transportation tube for collecting effluence of slurry into the first storage trough. The first storage trough is near the compression zone and in communication with the transportation tube. The second storage trough is corresponding to the blender and in communication with the transportation tube.

Other objects, advantages and novel features of the present invention will be drawn from the following detailed embodiments of the present invention with attached drawings, in which:

### BRIEF DESCRIPTION OF THE DRAWINGS

FIG. 1 is a schematic view of a slurry expressing and liquid displacing device in accordance with a first embodiment of the present invention; and

FIG. 2 is a schematic view of a slurry expressing and liquid displacing device in accordance with a second embodiment of the present invention.

### DESCRIPTION OF THE PREFERRED EMBODIMENTS

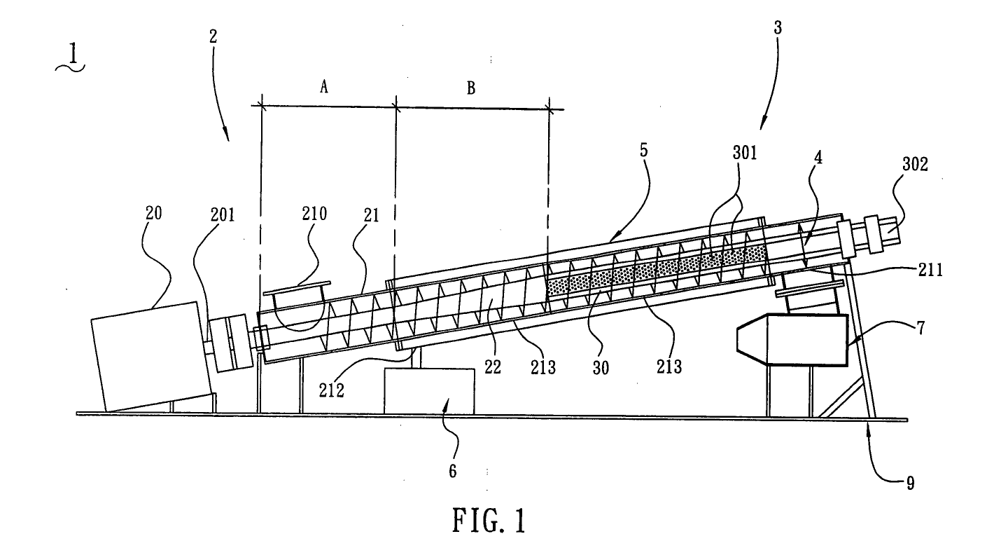

Referring to FIG. 1, a slurry expressing and liquid displacing device 1 in accordance with a first embodiment of the present invention is mounted on a slanting bracket 9 and includes a expressing mechanism 2, a displacing mechanism 3, a blender 4, a collecting tube 5 and first and second storage troughs 6, 7. The expressing mechanism 2 includes a driving motor 20, a transportation tube 21, and a first helical transmission shaft 22. The driving motor 20 is mounted on one end of the slanting bracket 9 with an axes 201 thereof rotatably connected with an end of the first helical transmission shaft 22. The transportation tube 21 has an inlet 210 at an end thereof near the driving motor 20 for slurry to flow into the transportation tube 21, and an outlet 211,212 at the other end thereof for separated effluence and solid of the slurry to flow out from the transportation tube 21. The second storage trough 7 is disposed under the outlet 211 for collecting the solid. The first storage trough 6 is disposed the outlet 212 for collecting the effluence of slurry therein, and a plurality of screens 213 located on the periphery surface of the transportation tube 21 opposite to the collecting tube 5 for providing the effluence of slurry into the first storage trough 6 too. The first helical transmission shaft 22 includes a transportation zone A for quickly transporting the slurry in the transportation tube 21, and a compression zone B for expressing the slurry into filtration cake in a gradually pressing manner. The compressing and filtrating functions of the compression zone B are realized by the first helical transmission shaft 22 with the different shaft diameters thereof which are gradually increased. Furthermore, the collecting tube 5 is disposed at the outside of the transportation tube 21 between the compression zone B and the displacing mechanism 3 and kept properly spaced from the transportation tube 21.

The displacing mechanism 3 is also disposed in the transportation tube 21 and includes a second helical transmission shaft 30 integrally formed with the first helical transmission shaft 22. The second helical transmission shaft 30 is hollow with a plurality of through holes 301 being disposed at the side surface thereof. Space between the through holes 301 is generally 0.5 mm. Each through hole 301 is formed with a slanting angle for facilitating the displacing liquid to flow out therethrough. A connecting port 302 is formed at an end of the second helical transmission shaft 30 for connecting with a complementary connecting port with displacing liquid such as water.

The blender 4 is disposed at the rear of the separating mechanism 3 and in the transportation tube 21 corresponding to the outlet 211 for scraping the separated solid congealing in the inner wall of the transportation tube 21 near the outlet 211 thereby collecting the solid in the second storage trough 7.

Thus, it is known from the above description that the slurry expressing and liquid displacing device 1 of the present invention is capable to express provided slurry into filtration cake through the quick and continuous helical transportation of the transportation zone A of the first helical transmission shaft 22 and through the compression zone B with gradually increased diameters of the first helical transmission shaft 22. The cake is radially pore volume displaced with external washing liquid (such as water) through the through holes 301 of the second helical transmission shaft 30 and thus the high purity solid are efficiently separated. During working in the transportation tube 21, separated the effluence of slurry into the first storage trough 6 through the screen 213 and the solid scraped from the wall of the blender 4 and collected into the second storage trough 7. Therefore, the slurry expressing and liquid displacing device of the present invention may be applied in fruit juice freeze-concentrating treatment, seawater desalting treatment, silt dehydration treatment and so on.

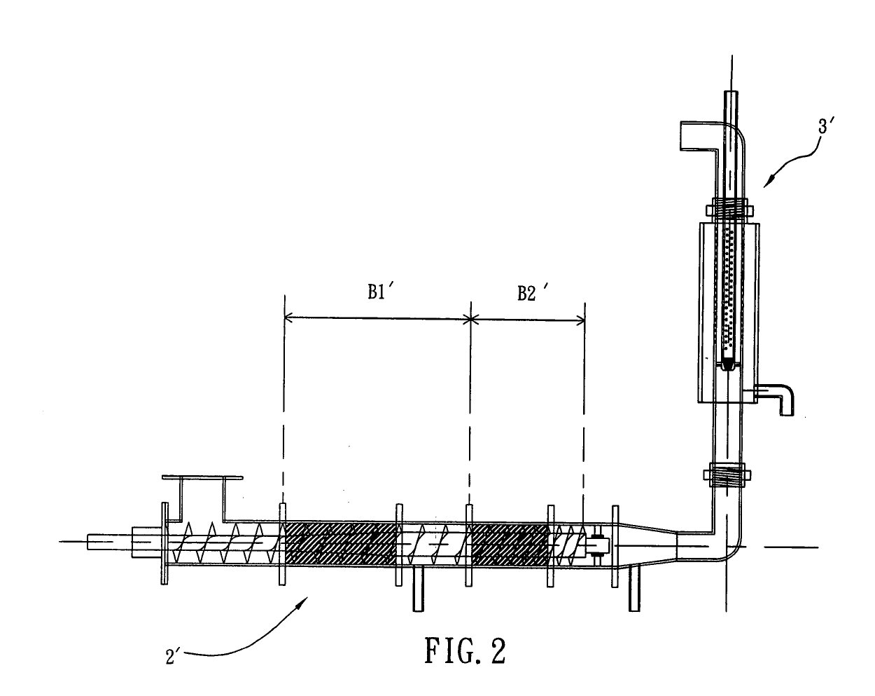

Referring to FIG. 2, a slurry expressing and liquid displacing device in accordance with a second embodiment of the present invention is similar to the above first embodiment except that a expressing mechanism 2′ and a displacing mechanism 3′ are generally perpendicular to each other, that is the expressing mechanism 2′ is configured along axis X and the displacing mechanism 3′ is along axis Y. The displacing mechanism 3′ not only saves space due to longitudinal configuration along the axis Y, but also has high displacing efficiency during the course of cross flow cake washing. Furthermore, the expressing mechanism 2′ has a first helical transmission shaft 21 with a compression zone which includes a front portion B1′ with gradually increased shaft diameters thereof and a rear portion B2′ with gradually reduced pitches of screws thereof. Thus, the expressing mechanism 2′ has a strong compression function.

It is understood that the invention may be embodied in other forms without departing from the spirit thereof. Thus, the present examples and embodiments are to be considered in all respects as illustrative and not restrictive, and the invention is not to be limited to the details given herein.

1. A slurry expressing and liquid displacing device, for expressing slurry and then separating out effluence and solid of the slurry through radial pore volume displacement of continuous washing, the slurry expressing and liquid displacing device comprising:
a expressing mechanism, comprising a driving motor, a transportation tube, and a first helical transmission shaft rotatably connected with the driving motor, the transportation tube having an inlet at an end thereof near the driving motor and an outlet at the other end thereof and a plurality of screens located at least on the periphery surface near the outlet, the first helical transmission shaft having a transportation zone at an end thereof near the inlet and a compression zone at the other end;
a displacing mechanism, disposed in the transportation tube and comprising a second helical transmission shaft rotatably connected with the first helical transmission shaft, the second helical transmission shaft being hollow with a plurality of through holes being defined at the side surface thereof, a connecting port being formed at an end of the second helical transmission shaft;
a blender formed at the rear of the displacing mechanism and in the transportation tube corresponding to the outlet;
a collecting tube, disposed at the outside of the transportation tube between the compression zone and the displacing mechanism and kept properly spaced from the transportation tube for collecting and guiding effluence and solid of the slurry;
a first storage trough, near the compression zone and in communication with the collecting tube; and
a second storage trough, corresponding to the blender and in communication with the transportation tube.

2. The slurry expressing and liquid displacing device as claimed in claim 1, the screens of the transportation tube are substantially located opposite to the collecting tube for providing the effluence of slurry from the transportation tube.

3. The slurry expressing and liquid displacing device as claimed in claim 1, further comprising a slanting bracket fixing and supporting the transportation tube at a slanting manner that the expressing mechanism locates lower and the displacing mechanism locates upper.

4. The slurry expressing and liquid displacing device as claimed in claim 3, wherein the expressing and filtrating functions of the compression zone of the first helical transmission shaft are realized by the different shaft diameters thereof which are gradually increased.

5. The slurry expressing and liquid displacing device as claimed in claim 3, wherein the expressing and filtrating functions of the compression zone of the first helical transmission shaft are realized by gradually reduced pitches of screws thereof.

6. The slurry expressing and liquid displacing device as claimed in claim 3, wherein the compressing and filtrating functions of the compression zone of the first helical transmission shaft are realized by gradually increased shaft diameters thereof and gradually reduced pitches of screws thereof.

7. The slurry expressing and liquid displacing device as claimed in claim 1, wherein the first and second helical transmission shafts are integrally formed.

8. The slurry expressing and liquid displacing device as claimed in claim 1, wherein space between the through holes of the second helical transmission shaft is generally 0.5 mm.

9. The slurry expressing and liquid displacing device as claimed in claim 1, wherein each through hole of the second helical transmission shaft is formed with a slanting angle.

10. The slurry expressing and liquid displacing device as claimed in claim 1, wherein the expressing mechanism and the displacing mechanism are generally perpendicular to each other, that is the expressing mechanism is configured along axis X and the displacing mechanism is along axis Y.
